(19) United States
(12) Patent Application Publication
(10) Pub. No.: US 2014/0098789 A1
(43) Pub. Date: Apr. 10, 2014

(54) METHOD, USER EQUIPMENT AND BASE STATION FOR INTEROPERATION BETWEEN WIRELESS LOCAL AREA NETWORK AND WIRELESS WIDE AREA NETWORK

(71) Applicant: Huawei Technologies Co., Ltd., Shenzhen (CN)

(72) Inventors: Hai LIU, Shenzhen (CN); Weisheng JIN, Shenzhen (CN); Peng ZHANG, Shenzhen (CN)

(73) Assignee: Huawei Technologies Co., Ltd., Shenzhen (CN)

(21) Appl. No.: 14/100,947

(22) Filed: Dec. 9, 2013

Related U.S. Application Data
(63) Continuation of application No. PCT/CN2012/076651, filed on Jun. 8, 2012.

(30) Foreign Application Priority Data
Jun. 8, 2011 (CN) 201110151880.9

(51) Int. Cl. H04W 36/00

(52) U.S. Cl. CPC H04W 36/0022
USPC 370/331

(57) ABSTRACT

Embodiments of the present invention provide a method for interoperation between a wireless local area network WLAN and a wireless wide area network WWAN, comprising: sending a wireless local area network media access control WLAN MAC address to a base station through a radio resource control RRC message; and accessing the WLAN network of the base station using the WLAN MAC address. In the method of the present invention, the WWAN and the WLAN can provide the user equipment and the base station with data service together or complementally, and the control method for the WWAN and the WLAN is simple.

### CROSS-REFERENCE TO RELATED APPLICATIONS

This application is a continuation of International Patent Application No. PCT/CN2012/076651, filed on Jun. 8, 2012, which claims priority to Chinese Patent Application No. 201110151880.9, filed on Jun. 8, 2011, both of which are hereby incorporated by reference in their entireties.

### TECHNICAL FIELD

The present invention relates to radio communication technologies, and more particularly, to a method, a user equipment and a base station for interoperation between a wireless local area network and a wireless wide area network.

### BACKGROUND

Long term evolution (LTE) is a wireless wide area network (WWAN) technology. LTE can support high-speed data service, can provide bearers for various services, and can ensure good quality of service. However, spectrum used by LTE needs to be paid for, and the LTE devices are relatively expensive in cost and relatively complicated in scheduling mechanism.

Wireless local area network (WLAN) can also support high-speed data service which uses free spectrum and has simpler scheduling mechanism. However, the WLAN DOES not have good quality of service assurance, therefore is suitable for best effort service such as internet.

Although the WLAN is cheaper and is complementary to the WWAN, the current WWAN network does not support the WLAN network at the same time, therefore, the WWAN and the WLAN fail to complement to each other for providing data service together.

### SUMMARY

Embodiments of the present invention provide a method, a user equipment and a base station for interoperation between a wireless local area network and a wireless wide area network to solve the problem that the WWAN and the WLAN fail to complement to each other for providing data service together.

An aspect of the present invention provides a method for interoperation between a wireless local area network WLAN and a wireless wide area network WWAN, the method comprising: receiving a first radio resource control RRC connection reconfiguration message sent from a base station, wherein the first RRC connection reconfiguration message instructs to transmit a bearer by the WLAN; and transmitting the bearer by the WLAN according to the first RRC connection reconfiguration message. A method for interoperation between the WLAN and the WWAN, comprising: receiving a first RRC connection reconfiguration message sent from a base station, wherein the first RRC connection reconfiguration message instructs to transmit a bearer by the WLAN; and transmitting the bearer by the WLAN with the base station according to the first RRC connection reconfiguration message.

Another aspect of the present invention provides a method for interoperation between a wireless local area network WLAN and a wireless wide area network WWAN, the method comprising: sending a first radio resource control RRC connection reconfiguration message to a user equipment, wherein the first RRC connection reconfiguration message instructs to transmit a bearer by the WLAN; and transmitting the bearer by the WLAN according to the first RRC connection reconfiguration message.

Still another aspect of the present invention provides a user equipment, communicating with a base station through a wireless local area network WLAN and a wireless wide area network WWAN, the user equipment comprising: a first communicating module and a first controlling module. The first communicating module is configured to receive a first RRC connection reconfiguration message sent from the base station, wherein the first RRC connection reconfiguration message instructs to transmit a bearer by the WLAN. The first controlling module is configured to control, according to the first RRC connection reconfiguration message received by the first communicating module, the first communicating module to transmit the bearer by the WLAN.

Still another aspect of the present invention provides a base station, communicating with a user equipment through a wireless local area network WLAN and a wireless wide area network WWAN, the base station comprising a second communicating module and a second controlling module. The second communicating module is configured to send a first RRC connection reconfiguration message to the user equipment, wherein the first RRC connection reconfiguration message instructs to transmit a bearer by the WLAN. The second controlling module is configured to transmit the bearer by the WLAN according to the first RRC connection reconfiguration message received by the second communicating module.

Still another aspect of the present invention provides a method for interoperation between a wireless local area network WLAN and a wireless wide area network WWAN, the method comprising: receiving a WLAN MAC address sent from the user equipment through an RRC message. Registering, if the user equipment has an authorization to use the WLAN network, the WLAN MAC address and allowing the user equipment to access the WLAN network using the WLAN MAC address.

Still another aspect of the present invention provides a user equipment, communicating with a base station through a wireless local area network WLAN and a wireless wide area network WWAN, the user equipment comprising: a third communicating module and a third controlling module. The third communicating module is configured to send a wireless local area network media access control WLAN MAC address to the base station through an RRC message. The third controlling module is configured to access the WLAN network using the WLAN MAC address.

Still another aspect of the present invention provides a base station, communicating with a user equipment through a wireless local area network WLAN and a wireless wide area network WWAN, the base station comprising: a fourth communicating module and a fourth controlling module. The fourth communicating module is configured to receive a WLAN MAC address sent from the user equipment through an RRC message. The fourth controlling module is configured to register, if the user equipment has an authorization to use the WLAN network, the WLAN MAC address received by the fourth communicating module and to allow the user equipment to access the WLAN network using the WLAN MAC address.

The method, user equipment and base station provided by the above-mentioned aspects for interoperation between a WLAN and a WWAN, make a user equipment to access the WWAN and the WLAN of a single base station by using an RRC message uniformly, or make a user equipment and a single base station to transmit a bearer to each other by the WWAN and/or the WLAN by using an RRC message uniformly. Therefore, the WWAN and the WLAN can provide the user equipment and the base station with data service together or complementally, and the control method for the WWAN and the WLAN is simple.

### BRIEF DESCRIPTION OF THE DRAWINGS

FIG. 1 is a flow chart illustrating a method for interoperation between a WLAN and a WWAN provided by an embodiment of the present invention;

FIG. 2 is a flow chart illustrating a method for interoperation between a WLAN and a WWAN provided by another embodiment of the present invention;

FIG. 3 is a flow chart illustrating a method for interoperation between a WLAN and a WWAN provided by still another embodiment of the present invention;

FIG. 4 is a flow chart illustrating a method for interoperation between a WLAN and a WWAN provided by still another embodiment of the present invention;

FIG. 5 is a flow chart illustrating a method for interoperation between a WLAN and a WWAN provided by still another embodiment of the present invention;

FIG. 6a is a schematic diagram illustrating a first protocol stack employed when a WLAN transmits bearer provided by the embodiment corresponding to FIG. 5;

FIG. 6b is a schematic diagram illustrating a second protocol stack employed when a WLAN transmits bearer provided by the embodiment corresponding to FIG. 5;

FIG. 6c is a schematic diagram illustrating a third protocol stack employed when a WLAN transmits bearer provided by the embodiment corresponding to FIG. 5;

FIG. 6d is a schematic diagram illustrating a fourth protocol stack employed when a WLAN transmits bearer provided by the embodiment corresponding to FIG. 5;

FIG. 7 is a flow chart illustrating a method for interoperation between a WLAN and a WWAN provided by still another embodiment of the present invention;

FIG. 8 is a flow chart illustrating a method for interoperation between a WLAN and a WWAN provided by still another embodiment of the present invention;

FIG. 9 is a flow chart illustrating a method for interoperation between a WLAN and a WWAN provided by still another embodiment of the present invention;

FIG. 10 is a structural diagram of a user equipment provided by an embodiment of the present invention;

FIG. 11 is a structural diagram of a base station provided by an embodiment of the present invention;

FIG. 12 is a structural diagram of a user equipment provided by another embodiment of the present invention; and

FIG. 13 is a structural diagram of a base station provided by another embodiment of the present invention.

### DESCRIPTION OF EMBODIMENTS

To make objectives, technical solutions and advantages of embodiments of the present invention clearer, a clear and complete description of technical solutions of the embodiments of the present invention will be given below, in combination with the accompanying drawings in the embodiments of the present invention. Apparently, the embodiments described below are only a part, but not all, of the embodiments of the present invention. All of other embodiments, obtained by those skilled in the art based on the embodiments of the present invention without any inventive efforts, fall into the protection scope of the present invention.

The WWAN provided in the embodiments of the present invention is preferably an LTE network, or a 3G network.

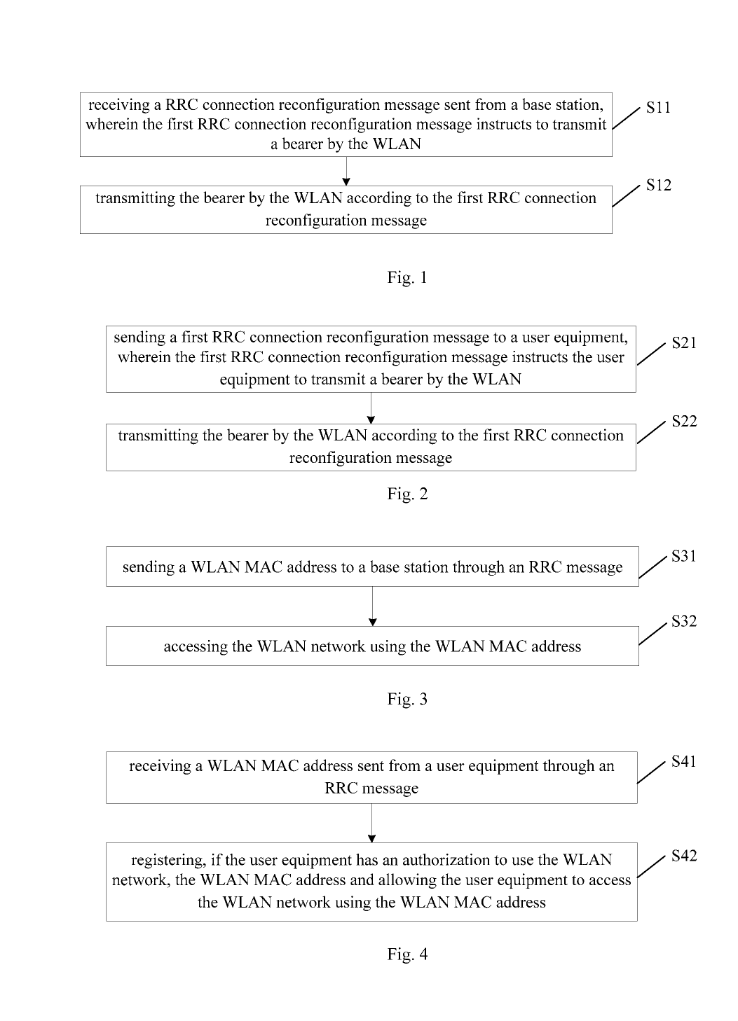

Referring to FIG. 1, FIG. 1 is a flow chart illustrating a method for interoperation between a WLAN and a WWAN provided by an embodiment of the present invention. The method for interoperation between the WLAN and the WWAN in this embodiment includes the following steps:

Step S11, receiving a first radio resource control (RRC) connection reconfiguration message sent from a base station, wherein the first RRC connection reconfiguration message instructs to transmit a bearer by the WLAN; and

Step S12, transmitting the bearer by the WLAN according to the first RRC connection reconfiguration message.

The method for interoperation between the WLAN and the WWAN according to this embodiment can transmit the bearer by the WLAN and/or the WWAN with a single base station, therefore, the WWAN and the WLAN can provide the user equipment (UE) and the base station with data service together or complementally. Additionally, the control on the WLAN uses an RRC message, which makes the control method for the WWAN and the WLAN simple.

Referring to FIG. 2, FIG. 2 is a flow chart illustrating a method for interoperation between a WLAN and a WWAN provided by another embodiment of the present invention. The method for interoperation between the WLAN and the WWAN in this embodiment includes the following steps:

Step S21, sending a first RRC connection reconfiguration message to a UE, wherein the first RRC connection reconfiguration message instructs the UE to transmit a bearer by the WLAN; and

Step S22, transmitting the bearer by the WLAN according to the first RRC connection reconfiguration message.

The method for interoperation between the WLAN and the WWAN provided by this embodiment can transmit the bearer by the WLAN and/or the WWAN with a single base station, therefore, the WWAN and the WLAN can provide the UE and the base station with data service together or complementally. Additionally, the control on the WLAN uses an RRC message, which makes the control method for the WWAN and the WLAN simple.

Referring to FIG. 3, FIG. 3 is a flow chart illustrating a method for interoperation between a WLAN and a WWAN provided by still another embodiment of the present invention. The method for interoperation between the WLAN and the WWAN in this embodiment includes the following steps.

Step S31, sending a wireless local area network media access control (WLAN Media Access Control, WLAN MAC) address to a base station through an RRC message.

In an implementation of this embodiment, a UE establishes an RRC connection with a base station, sends the WLAN MAC address to the base station through the RRC message after the RRC connection is established. The WLAN MAC address refers to an MAC address of a WLAN network card of the user equipment. The base station may be informed of the WLAN MAC address through an RRC setup complete message, or a specialized RRC message.

Step S32, accessing the WLAN network using the WLAN MAC address.

In an implementation of this embodiment, if the UE is authorized to use the WLAN as authenticated by the base station, the WLAN MAC address provided by the UE is deemed as legal, and the UE can use the WLAN MAC address to transceive a WLAN frame with the base station. Otherwise, the UE cannot use the WLAN network.

In an implementation of this embodiment, a list of UE(s) authorized to use WLAN may be pre-configured on the base station, and the base station authenticates whether the UE is allowed to use the WLAN.

In an implementation of this embodiment, the UE authorized to use the WLAN may be indicated by a core network. For example, an MME obtains subscriber data from a home subscriber service (HSS) to determine the authorization of the UE, and the MME informs the base station of whether the UE is allowed to use the WLAN in a context establishment or modification message.

In an implementation of this embodiment, if the UE is authorized to use the WLAN, the base station registers the WLAN MAC address in a context of the UE, and allows the WLAN MAC address to use the corresponding WLAN network.

Referring to FIG. 4, FIG. 4 is a flow chart illustrating a method for interoperation between a WLAN and a WWAN provided by still another embodiment of the present invention. The method for interoperation between the WLAN and the WWAN in this embodiment includes the following steps:

Step S41, receiving a WLAN MAC address sent from a user equipment through an RRC message; and

Step S42, registering, if the user equipment has an authorization to use the WLAN network, the WLAN MAC address and allowing the user equipment to access the WLAN network using the WLAN MAC address.

The implementations of this embodiment can refer to the corresponding implementations of embodiment in FIG. 3, and will not be described redundantly herein.

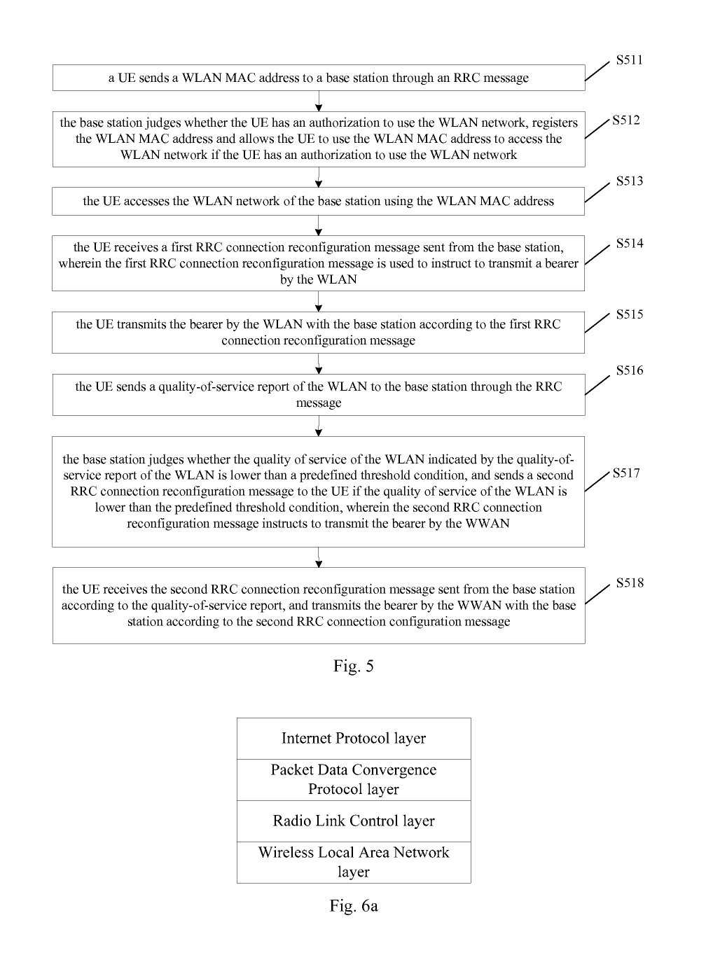

Referring to FIG. 5, FIG. 5 is a flow chart illustrating a method for interoperation between a WLAN and a WWAN provided by still another embodiment of the present invention. The method for interoperation between the WLAN and the WWAN in this embodiment includes the following steps.

Step S511, a UE sends a WLAN MAC address to a base station through an RRC message.

In an implementation of this embodiment, the UE establishes an RRC connection with a base station, sends the WLAN MAC address to the base station through the RRC message after the RRC connection is established. The WLAN MAC address refers to an MAC address of a WLAN network card of the UE. The base station may be informed of the WLAN MAC address through an RRC setup complete message, or a specialized RRC message.

Step S512, the base station judges whether the UE has an authorization to use the WLAN network, registers the WLAN MAC address and allows the UE to use the WLAN MAC address to access the WLAN network if the UE has an authorization to use the WLAN network.

In an implementation of this embodiment, if the UE is authorized to use the

WLAN as authenticated by the base station, the WLAN MAC address provided by the UE is deemed as legal, and the UE can use the WLAN MAC address to transceive a WLAN frame with the base station. Otherwise, the UE cannot use the WLAN network.

In an implementation of this embodiment, a list of UE(s) authorized to use the WLAN may be pre-configured on the base station, and the base station authenticates whether the UE is allowed to use the WLAN.

In an implementation of this embodiment, the UE authorized to use the WLAN may be indicated by a core network. For example, an MME obtains subscriber data from a home subscriber service (HSS) to determine the authorization of the UE, and the MME informs the base station of whether the UE is allowed to use the WLAN in a context establishment or modification message.

In an implementation of this embodiment, if the UE is authorized to use the WLAN, the base station registers the WLAN MAC address in a context of the UE and allows the WLAN MAC address to use the corresponding WLAN network.

Step S513, the UE accesses the WLAN network of the base station using the WLAN MAC address.

Step S514, the UE receives a first RRC connection reconfiguration message sent from the base station, wherein the first RRC connection reconfiguration message instructs to transmit a bearer by the WLAN.

In an implementation of this embodiment, the first RRC connection reconfiguration message is generated by the base station on the basis of the quality of service (QoS) of the WWAN. If the WWAN is block, the base station may decide to transmit the bearer in the WLAN, that is, the base station may inform the UE to choose the WLAN to transmit the bearer through the first RRC connection reconfiguration message.

In another implementation of this embodiment, the first RRC connection reconfiguration message is generated by the base station according to an operator strategy. The operator strategy may be sent from a core network to the base station.

Step S515, the UE transmits the bearer by the WLAN with the base station according to the first RRC connection reconfiguration message.

In implementations of this embodiment, the WLAN may use a first protocol stack, a second protocol stack, a third protocol stack or a fourth protocol stack to transmit the bearer.

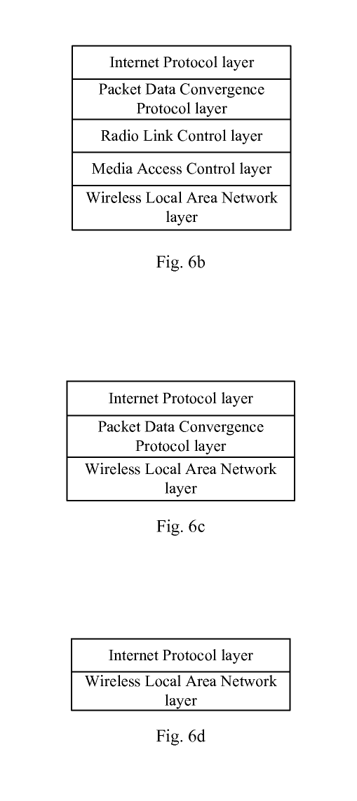

Referring to FIG. 6a, FIG. 6a is a schematic diagram illustrating a first protocol stack employed when a WLAN transmits a bearer provided by the embodiment corresponding to FIG. 5. In turn from bottom to top, the first protocol stack includes a WLAN layer, a radio link control protocol (RLC) layer, a packet data convergence protocol (PDCP) layer and an internet protocol IP layer. The protocols of the WLAN layer include 802.2LLC (Logical Link Control), 802.11MAC (Media Access Control) and 802.11PHY (Physical Layer). The PDCP layer can maintain service continuity in handover, so that the UE can maintain service continuity in handover between the base station which supports the WWAN and the WLAN at the same time and other base station. The RLC layer can control the segmentation and retransmission of packets, ensure the accuracy of packets in transmission, and, on the base station side, distinguish the UEs according to the original WLAN MAC addresses of WLAN frames and distinguish the bearers according to the logical path numbers of the RLC layer.

Referring to FIG. 6b, FIG. 6b is a schematic diagram illustrating a second protocol stack employed when a WLAN transmits a bearer provided by the embodiment corresponding to FIG. 5. In turn from bottom to top, the second protocol stack includes a WLAN layer, an MAC layer, an RLC layer, a PDCP layer and an IP layer.

Referring to FIG. 6c, FIG. 6c is a schematic diagram illustrating a third protocol stack employed when a WLAN transmits a bearer provided by the embodiment corresponding to FIG. 5. In turn from bottom to top, the third protocol stack includes a WLAN layer, a PDCP layer and an IP layer.

Referring to FIG. 6d, FIG. 6d is a schematic diagram illustrating a fourth protocol stack employed when a WLAN transmits a bearer provided by the embodiment corresponding to FIG. 5. In turn from bottom to top, the fourth protocol stack includes a WLAN layer and an IP layer.

Step S516, the UE sends a quality-of-service report of the WLAN to the base station through the RRC message.

For example, the UE can send the quality-of-service report to the base station through the RRC message. The content of the quality-of-service report may include that the UE fails to access the WLAN, the UE finds the WLAN blocking after accessing the WLAN successfully, or the UE finds the number of retransmission times too large or the lost packets too many.

Step S517, the base station judges whether the quality of service of the WLAN indicated by the quality-of-service report of the WLAN is lower than a predefined threshold condition, and sends a second RRC connection reconfiguration message to the UE if the quality of service of the WLAN is lower than the predefined threshold condition, wherein the second RRC connection reconfiguration message instructs to transmit the bearer by the WWAN.

For example, the quality-of-service report of the WLAN may include parameter(s) indicating the number of retransmission times and/or the number of lost packets of the WLAN. If the number of retransmission times and/or the number of lost packets are/is larger than predefined one(s), the base station sends the second RRC connection reconfiguration message to the UE, so as to instruct the UE to transmit the bearer by the WWAN.

Step S518, the UE receives the second RRC connection reconfiguration message sent from the base station according to the quality-of-service report, and transmits the bearer by the WWAN with the base station according to the second RRC connection configuration message.

The method for interoperation between the WLAN and the WWAN provided by this embodiment may employ uniformly the RRC message to access the WWAN and the WLAN with a single base station, that is, the access to the WLAN is accomplished together with the access to the WWAN. Therefore, access control signallings are reduced as compared with those in accesses to the WWAN and the WLAN separately, so that the method for accessing is simpler.

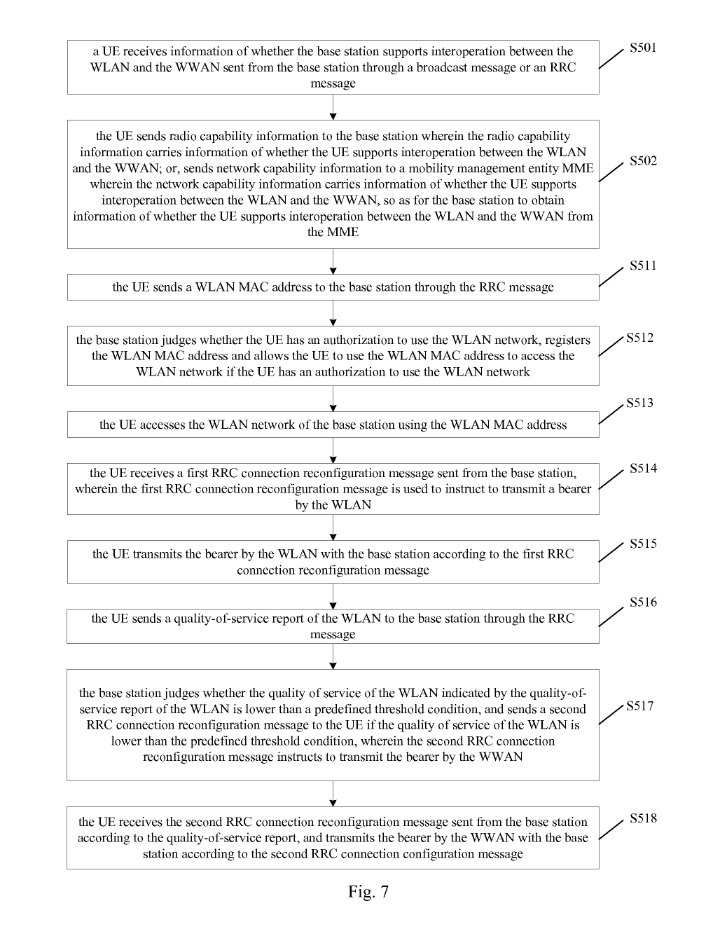

Referring to FIG. 7, FIG. 7 is a flow chart illustrating a method for interoperation between a WLAN and a WWAN provided by still another embodiment of the present invention. The method in this embodiment is substantially the same as the solution in the embodiment of FIG. 5, with main difference in including step S501 and step S502 before step S511.

S501, optionally, a UE receives information of whether the base station supports interoperation between the WLAN and the WWAN sent from the base station through a broadcast message or an RRC message.

In an implementation of this embodiment, the UE needs to know the ability about whether the network supports interoperation between the WLAN and the WWAN. The UE can receive a system message broadcast from the base station, wherein the system message includes information of whether the base station supports interoperation between the WLAN and the WWAN. In another implementation of this embodiment, the UE receives an RRC message or an NAS message sent from the base station after the RRC connection is established, wherein the RRC message or the NAS message includes information of whether the base station supports interoperation between the WLAN and the WWAN.

Step S502, optionally, the UE sends radio capability information to the base station wherein the radio capability information carries information of whether the UE supports interoperation between the WLAN and the WWAN; or, the UE sends network capability information to a mobility management entity (MME) wherein the network capability information carries information of whether the UE supports interoperation between the WLAN and the WWAN, so as for the base station to obtain information of whether the UE supports interoperation between the WLAN and the WWAN from the MME.

In an implementation of this embodiment, the network side needs to know the ability about whether the UE supports interoperation between the WLAN and the WWAN. The UE may send to the base station the radio capability information which carries information of the UE supports interoperation between the WLAN and the WWAN. In another implementation of this embodiment, the UE may send to the MME the network capability information which carries information of the UE supports interoperation between the WLAN and the WWAN, then the MME sends it to the base station by adding a field in a context establishment or modification message. The step S502 is optional, and the base station may also judge that the UE has the ability of interoperation between the WLAN and the WWAN according to the fact that the UE sends the WLAN MAC address in step S511.

Step S511, the UE sends a WLAN MAC address to the base station through the RRC message if the UE and the base station both support interoperation between the WLAN and the WWAN.

Steps S512 to S518 are the same as the method of embodiments corresponding to FIG. 5, and will not be described redundantly herein.

In the method for interoperation between the WLAN and the WWAN provided by this embodiment, the base station can decide to transmit the bearer by the WWAN or the WLAN according to the quality-of-service report reported by the UE, therefore, a service is enabled to be provided by using the WWAN and the WLAN complementally and the quality of service is better.

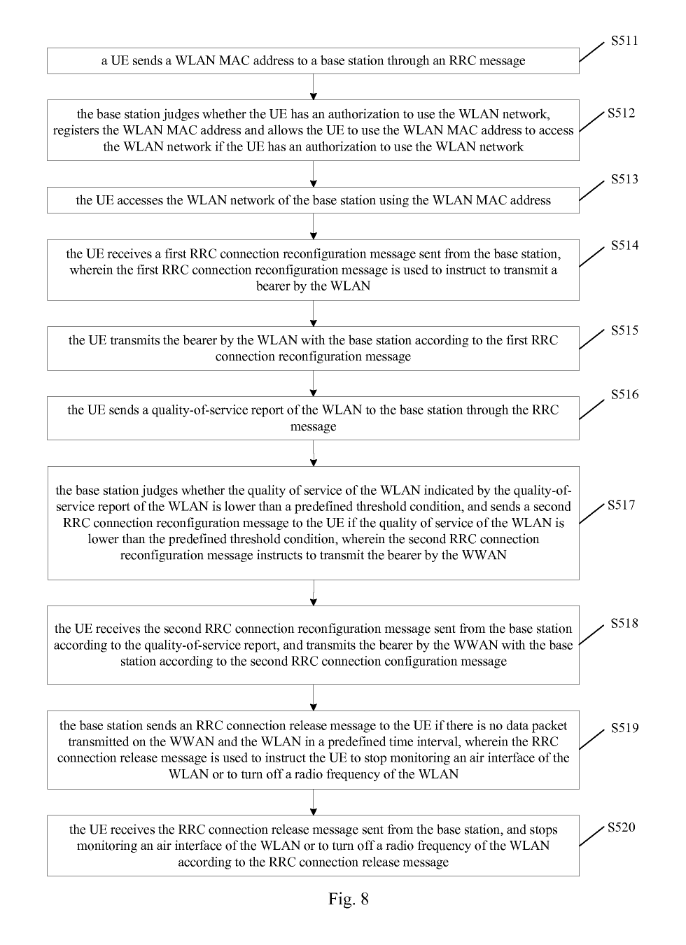

Referring to FIG. 8, FIG. 8 is a flow chart illustrating a method for interoperation between a WLAN and a WWAN provided by still another embodiment of the present invention. The method in this embodiment is substantially the same as the solution in the embodiment of FIG. 5, with main difference in including step S519 and step S520 after step S518.

Step S519, preferably, the base station sends an RRC connection release message to the UE if there is no data packet transmitted on the WWAN and the WLAN in a predefined time interval, wherein the RRC connection release message instructs the UE to stop monitoring an air interface of the WLAN or to turn off a radio frequency of the WLAN.

In an implementation of this embodiment, the base station sends an RRC connection release message to the UE if the base station detects that UE does not transmit a data packet on either the WWAN or the WLAN in a predefined time interval.

Step S520, preferably, the UE receives the RRC connection release message sent from the base station, and stops monitoring an air interface of the WLAN or turns off a radio frequency of the WLAN according to the RRC connection release message.

In the related art, the UE monitors the air interface of the WLAN constantly to determine whether the UE can send a packet or whether the UE has a packet to receive. In this embodiment, UE stops monitoring the air interface of the WLAN or turns off the radio frequency of the WLAN on receipt of the RRC connection release message from the base station.

In the method for interoperation between the WLAN and the WWAN provided by this embodiment, the base station sends the RRC connection release message to the UE if there is no data packet transmitted on both the WWAN and the WLAN in a predefined time interval, and instructs the UE to stop monitoring the air interface of the WLAN or to turn off the radio frequency of the WLAN, so that the UE can save more power.

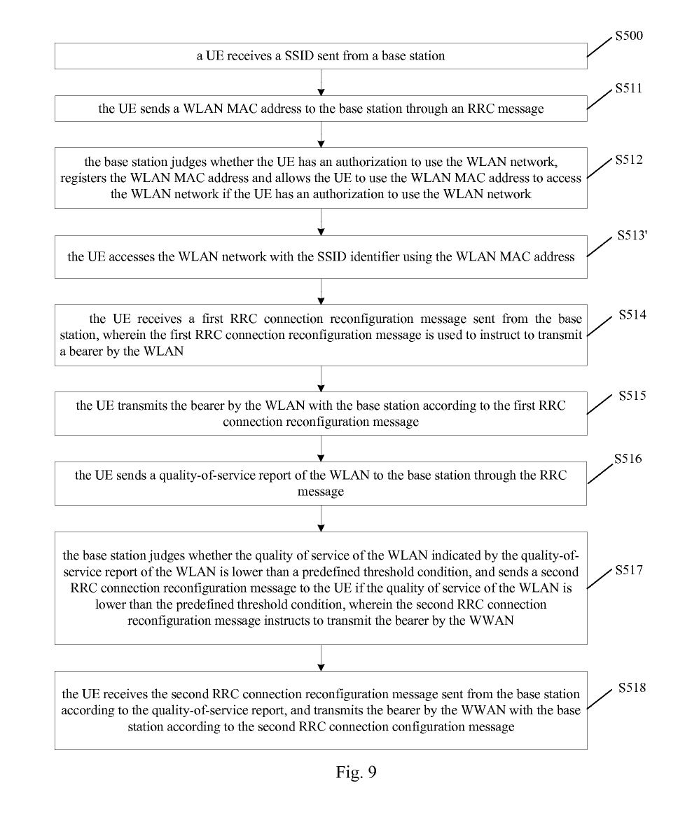

Referring to FIG. 9, FIG. 9 is a flow chart illustrating a method for interoperation between a WLAN and a WWAN provided by still another embodiment of the present invention. The method for interoperation between the WLAN and the WWAN in this embodiment is substantially the same as that in FIG. 5, with the main differences as follows.

Step S500 is included before step S511 of receiving a service set identifier (SSID) sent from the base station.

In an implementation of this embodiment, step S500 may be performed simultaneously with the step S501 in the embodiment of FIG. 7, that is the SSID is added in the broadcast message in step S501. In an implementation of this embodiment, step S500 is a separate step before step S513, wherein the base station sends the SSID through an RRC message.

Step S513 is replaced by step S513′ in this embodiment where the UE accesses the WLAN network with the SSID identifier using the WLAN MAC address.

The rest steps are the same with those in the embodiments in FIG. 5, and will not be described redundantly herein.

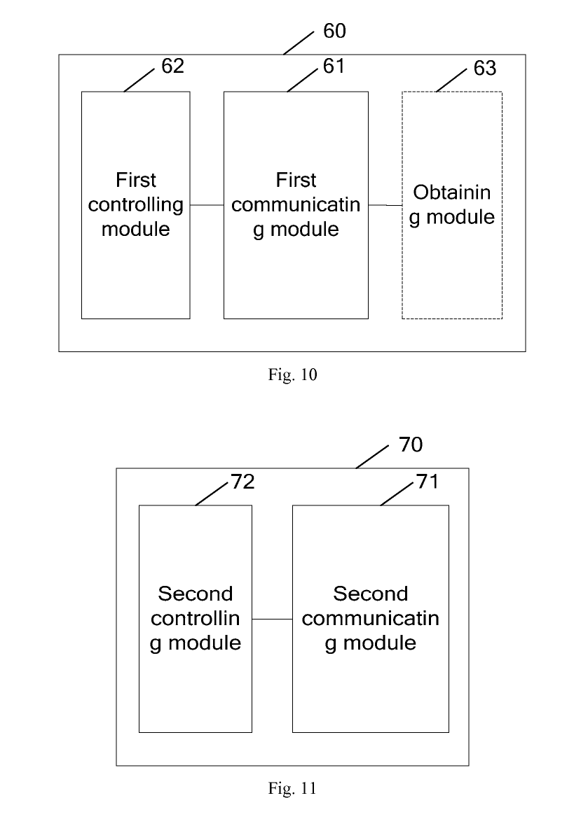

Referring to FIG. 10, FIG. 10 is a structural diagram of a user equipment provided by an embodiment of the present invention. The UE 60 is configured to implement the method for interoperation between a WLAN and a WWAN provided by the embodiment corresponding to FIG. 1. The UE 60 includes a first communicating module 61 and a first controlling module 62. The first communicating module 61 is configured to receive a first RRC connection reconfiguration message sent from the base station, wherein the first RRC connection reconfiguration message instructs to transmit a bearer by the WLAN. The first controlling module 62 is configured to control, according to the first RRC connection configuration message received by the first communicating module 61, the first communicating module 61 to transmit the bearer by the WLAN.

In another implementation of this embodiment, UE 60 is further configured to implement the method for interoperation between the WLAN and the WWAN provided by the embodiment corresponding to FIG. 5. The UE 60 further includes an obtaining module 63, which is configured to obtain a quality-of-service report of WLAN. The first communicating module 61 is further configured to send the quality-of-service report of the WLAN to the base station, and to receive a second RRC connection reconfiguration message from the base station according to the quality-of-service report, wherein the second RRC connection configuration message instructs to transmit the bearer by the WWAN. The first controlling module 62 is further configured to control, according to the second RRC connection reconfiguration message received by the first communicating module 61, the first communicating module 61 to transmit the bearer by the WWAN.

In another implementation of this embodiment, UE 60 is further configured to implement the method for interoperation between the WLAN and the WWAN provided by the embodiment corresponding to FIG. 7. The obtaining module 63 is further configured to obtain a WLAN MAC address. The first communicating module 61 is further configured to send the WLAN MAC address obtained by the obtaining module 63 to the base station through an RRC message. The first controlling module 62 is further configured to control the first communicating module 61 to access the WLAN network of the base station using the WLAN MAC address.

In another implementation of this embodiment, UE 60 is further configured to implement the method for interoperation between the WLAN and the WWAN provided by the embodiment corresponding to FIG. 8. The first communicating module 61 is further configured to receive an RRC connection release message sent from the base station. The first controlling module 62 is further configured to control, according to the RRC connection release message received by the first communicating module 61, the first communicating module 61 to stop monitoring an air interface of the WLAN or to turn off a radio frequency of the WLAN.

Referring to FIG. 11, FIG. 11 is a structural diagram of a base station provided by an embodiment of the present invention. The base station 70 is configured to implement the method for interoperation between the WLAN and the WWAN provided by the embodiment corresponding to FIG. 2. The base station 70 includes a second communicating module 71 and a second controlling module 72. The second communicating module 71 is configured to send a first RRC connection reconfiguration message to the UE, wherein the first RRC connection reconfiguration message instructs to transmit a bearer by the WLAN. The second controlling module 72 is configured to transmit the bearer by the WLAN according to the first RRC connection configuration message received by the second communicating module.

In another implementation of this embodiment, the base station 70 is further configured to implement the method for interoperation between the WLAN and the WWAN provided by the embodiment corresponding to FIG. 5. The second communicating module 71 is further configured to receive a quality-of-service report of the WLAN sent from the UE. The second controlling module 72 is configured to determine, according to the quality-of-service report received by the second communicating module 71, whether the quality of service of the WLAN indicated by the quality-of-service report of the WLAN is lower than a predefined threshold condition, and to control the second communicating module 71 to send a second RRC connection reconfiguration message to the UE if the quality of service is lower than the predefined threshold condition, wherein the second RRC connection reconfiguration message instructs to transmit the bearer by the WWAN.

In still another implementation of this embodiment, the base station 70 is further configured to implement the method for interoperation between the WLAN and the WWAN provided by the embodiment corresponding to FIG. 7. The second communicating module 71 is further configured to receive a WLAN MAC address sent form the UE through an RRC message. The second controlling module 72 is configured to determine whether the UE has an authorization to use the WLAN network, to register the WLAN MAC address if the UE has an authorization, and to allow the UE to access the WLAN network using the WLAN MAC address.

In still another implementation of this embodiment, the base station 70 is further configured to implement the method for interoperation between the WLAN and the WWAN provided by the embodiment corresponding to FIG. 8. The second controlling module 72 is further configured to control the second communicating module 71 to send an RRC connection release message to the UE if there is no data packet transmitted on the WWAN and the WLAN in a predefined time interval, wherein the RRC connection release message instructs the UE to stop monitoring an air interface of the WLAN or to turn off a radio frequency of the WLAN.

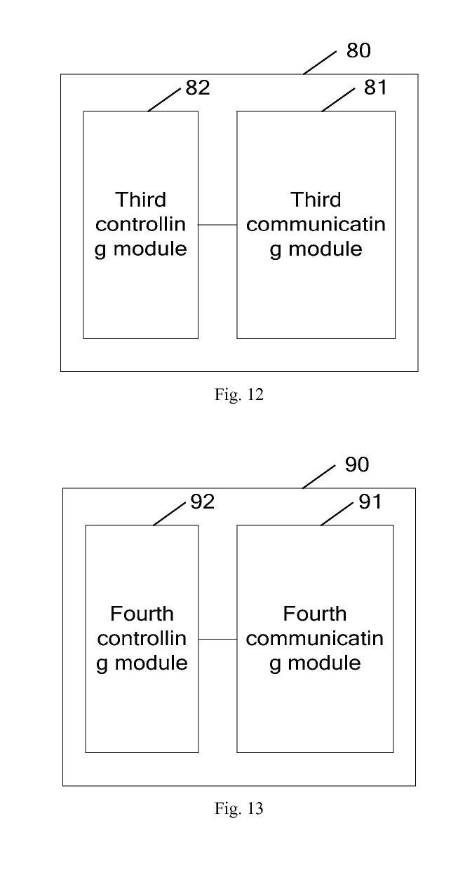

Referring to FIG. 12, FIG. 12 is a structural diagram of a user equipment provided by another embodiment of the present invention. The UE 80 is configured to implement the method for interoperation between the WLAN and the WWAN provided by the embodiment corresponding to FIG. 3. The UE 80 includes a third communicating module 81 and a third controlling module 82. The third communicating module 81 is configured to send a wireless local area network media access control WLAN MAC address to the base station through an RRC message. The third controlling module 82 is configured to access the WLAN network using the WLAN MAC address.

In another implementation of this embodiment, the third communicating module 81 is specifically configured to receive information of whether the base station supports the interoperation between the WLAN and the WWAN from the base station; and to send radio capability information to the base station wherein the radio capability information carries information of whether the user equipment supports interoperation between the WLAN and the WWAN, or, to send network capability information to a mobility management entity MME, wherein the network capability information carries information of whether the user equipment supports interoperation between the WLAN and the WWAN, so as for the base station to obtain the information of whether the user equipment supports interoperation between the WLAN and the WWAN from the MME; and to send the WLAN MAC address to the base station through the RRC message if the user equipment and the base station both support interoperation between the WLAN and the WWAN.

Referring to FIG. 13, FIG. 13 is a structural diagram of a base station provided by another embodiment of the present invention. The base station 90 is configured to implement the method for interoperation between the WLAN and the WWAN provided by the embodiment corresponding to FIG. 4. The base station 90 includes a fourth communicating module 91 and a fourth controlling module 92. The fourth communicating module 91 is configured to receive a WLAN MAC address sent from the user equipment through an RRC message. The fourth controlling module 92 is configured to register, if the user equipment has an authorization to use the WLAN network, the WLAN MAC address received by the fourth communicating module 91 and to allow the user equipment to access the WLAN network using the WLAN MAC address.

In another implementation of this embodiment, the fourth communicating module 91 is further configured to send information of whether the base station supports interoperation between the WLAN and the WWAN to the user equipment; and to receive the radio capability information sent from the user equipment wherein the radio capability information carries information of whether the user equipment supports interoperation between the WLAN and the WWAN, or to obtain information of whether the user equipment supports interoperation between the WLAN and the WWAN from an MME, wherein the information of whether the user equipment supports interoperation between the WLAN and the WWAN on the MME is sent from the user equipment to the MME through network capability information.

In the end, it should be noted that, it can be appreciated for those of ordinary skill in the art that all or a part of the procedures in the above-mentioned embodiment methods may be implemented with a computer program instructing corresponding hardware. The above-mentioned program may be stored in a computer readable storage medium. The procedures of the embodiments of the respective methods mentioned above may be included when the program is executed. The above-mentioned storage medium may be a magnetic disk, an optical disk, a read only memory (ROM), a random access memory (RAM), or the like.

The functional units in an embodiment of the present invention may be integrated in a processing module, or may be physically separate units, or two or more units may be integrated in one module. The above-mentioned integrated module may be implemented in the form of hardware, or in the form of combination of software and hardware. When the above-mentioned integrated module is implemented in the form of software and is sold or used as a separate product, it also may be stored in a computer readable storage medium. The above-mentioned storage medium may be a read only memory, a magnetic disk, an optical disk, or the like. The above-mentioned device or system can implement the method in the corresponding embodiment.

The foregoing descriptions are merely preferable embodiments of the invention, rather than limiting the invention. Any modification, equivalent alteration or improvement within the spirit and principle of the invention shall fall into the protection scope of the invention.

What is claimed is:

1. A method for interoperation between a wireless local area network WLAN and a wireless wide area network WWAN, the method comprising:
receiving a first radio resource control RRC connection reconfiguration message sent from a base station, wherein the first RRC connection reconfiguration message instructs to transmit a bearer by the WLAN; and
transmitting the bearer by the WLAN according to the first RRC connection reconfiguration message.

2. The method of claim 1, the method further comprising:
sending a quality-of-service report of the WLAN to the base station;
receiving a second RRC connection reconfiguration message sent from the base station according to the quality-of-service report, wherein the second RRC connection reconfiguration message instructs to transmit the bearer by the WWAN; and
transmitting the bearer by the WWAN according to the second RRC connection reconfiguration message.

3. The method of claim 1, the method further comprising:
receiving an RRC connection release message sent from the base station; and
stopping monitoring an air interface of the WLAN or turning off a radio frequency of the WLAN according to the RRC connection release message.

4. The method of claim 1, before receiving the first RRC connection reconfiguration message sent from the base station, the method further comprising:
sending a wireless local area network media access control WLAN MAC address to the base station through an RRC message; and
accessing the WLAN network using the WLAN MAC address.

5. The method of claim 4, before sending a WLAN MAC address to the base station through an RRC message, the method further comprising:
receiving information of whether the base station supports interoperation between the WLAN and the WWAN sent from the base station; and
sending radio capability information to the base station wherein the radio capability information carries information of whether a user equipment supports interoperation between the WLAN and the WWAN, or, sending network capability information to a mobility management entity MME wherein the network capability information carries information of whether the user equipment supports interoperation between the WLAN and the WWAN, so as for the base station to obtain the information of whether the user equipment supports interoperation between the WLAN and the WWAN from the MME; and
wherein sending a WLAN MAC address to base station through an RRC message comprises:
sending the WLAN MAC address to the base station through the RRC message if the user equipment and the base station both support interoperation between the WLAN and the WWAN.

6. The method of claim 4, the method further comprising:
receiving a service set identifier SSID sent from the base station; and
wherein accessing the WLAN network of the base station using the WLAN MAC address comprises:
accessing the WLAN network with the SSID identifier using the WLAN MAC address.

7. The method of claim 1, wherein transmitting the bearer by the WLAN comprises: transmitting the bearer using a first protocol stack, a second protocol stack, a third protocol stack or a fourth protocol stack, wherein,
the first protocol stack comprises, in turn from bottom to top, a WLAN layer, a radio link control protocol RLC layer, a packet data convergence protocol PDCP layer and an internet protocol IP layer;
the second protocol stack comprises, in turn from bottom to top, a WLAN layer, an MAC layer, an RLC layer, a PDCP layer and an IP layer;
the third protocol stack comprises, in turn from bottom to top, a WLAN layer, a PDCP layer and an IP layer; and
the fourth protocol stack comprises, in turn from bottom to top, a WLAN layer and an IP layer.

8. A user equipment communicating with a base station through a wireless local area network WLAN and a wireless wide area network WWAN, the user equipment comprising a first communicating module and a first controlling module, wherein
the first communicating module is configured to receive a first RRC connection reconfiguration message sent from the base station, wherein the first RRC connection reconfiguration message instructs to transmit a bearer by the WLAN; and
the first controlling module is configured to control, according to the first RRC connection reconfiguration message received by the first communicating module, the first communicating module to transmit the bearer by the WLAN.

9. The user equipment of claim 8, the user equipment further comprising an obtaining module, wherein
the obtaining module is configured to obtain a quality-of-service report of the WLAN;
the first communicating module is further configured to send the quality-of-service report of the WLAN to the base station, and receive a second RRC connection reconfiguration message sent from the base station according to the quality-of-service report, wherein the second RRC connection configuration message instructs to transmit the bearer by the WWAN; and
the first controlling module is further configured to control, according to the second RRC connection reconfiguration message received by the first communicating module, the first communicating module to transmit the bearer by the WWAN.

10. The user equipment of claim 8, wherein the first communicating module is further configured to receive an RRC connection release message sent from the base station; and
the first controlling module is further configured to control, according to the RRC connection release message received by the first communicating module, the first communicating module to stop monitoring an air interface of the WLAN or to turn off a radio frequency of the WLAN.

11. The user equipment of claim 8, wherein
the obtaining module is further configured to obtain a WLAN MAC address;
the first communicating module is further configured to send the WLAN MAC address obtained by the obtaining module to the base station through an RRC message; and
the first controlling module is further configured to control the first communicating module to access the WLAN network of the base station using the WLAN MAC address.

12. A base station communicating with a user equipment through a wireless local area network WLAN and a wireless wide area network WWAN, the base station comprising a second communicating module and a second controlling module, wherein
the second communicating module is configured to send a first RRC connection reconfiguration message to the user equipment, wherein the first RRC connection reconfiguration message instructs to transmit a bearer by the WLAN; and
the second controlling module is configured to transmit the bearer by the WLAN according to the first RRC connection reconfiguration message received by the second communicating module.

13. The base station of claim 12, wherein
the second communicating module is further configured to receive a quality-of-service report of the WLAN sent from the user equipment; and
the second controlling module is further configured to determine, according to the report received by the second communicating module, whether the quality of service of the WLAN indicated by the quality-of-service report of the WLAN is lower than a predefined threshold condition, and to control the second communicating module to send a second RRC connection reconfiguration message to the user equipment if it is lower than the predefined threshold condition, wherein the second RRC connection reconfiguration message instructs to transmit the bearer by the WWAN.

14. The base station of claim 12, wherein
the second controlling module is further configured to control the second communicating module to send an RRC connection release message to the user equipment if there is no data packet transmitted on the WWAN and the WLAN in a predefined time interval, wherein the RRC connection release message instructs the user equipment to stop monitoring an air interface of the WLAN or to turn off a radio frequency of the WLAN.

15. The base station of claim 12, wherein
the second communicating module is further configured to receive a WLAN MAC address sent from the user equipment through an RRC message; and
the second controlling module is further configured to determine whether the user equipment has an authorization to use the WLAN network, to register the WLAN MAC address if the user equipment has the authorization and to allow the user equipment to access the WLAN network using the WLAN MAC address.
